(19) United States
(12) Patent Application Publication
(10) Pub. No.: US 2016/0209968 A1
(43) Pub. Date: Jul. 21, 2016

(54) MAPPING TOUCH INPUTS TO A USER INPUT MODULE

(71) Applicant: Microsoft Technology Licensing, LLC, Redmond, WA (US)

(72) Inventors: Stuart Taylor, Cambridge (GB); Christopher J Lovett, Woodinville, WA (US); Stephen E. Hodges, Cambridge (GB); John Franciscus Marie Helmes, Steyl (NL)

(21) Appl. No.: 14/599,286

(22) Filed: Jan. 16, 2015

(51) Int. Cl. G06F 3/041

(52) U.S. Cl. CPC G06F 3/0412; G06F 3/0416

(57) ABSTRACT

A method for mapping touch inputs to inputs on a user input module is described. Touch event data resulting from users interacting with a touch-based application is received at a computing resource. This touch event data is analyzed to identify touch inputs to the application and the analysis is performed independently of the code for the application. Mapping data is then generated which identifies at least one mapping between an identified touch input to the application and a user input via a user input module.

### BACKGROUND

There are large numbers of computing devices that have touch-sensitive screens which allow users to interact using touch gestures directly on the device's screen. Examples include smartphones, tablet computers, large interactive surface computers and touch-sensitive displays for desktop computers. Many games that run on such computing devices are operated solely by touch inputs.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A method for mapping touch inputs to inputs on a user input module is described. Touch event data resulting from users interacting with a touch-based application is received at a computing resource. This touch event data is analyzed to identify touch inputs to the application and the analysis is performed independently of the code for the application. Mapping data is then generated which identifies at least one mapping between an identified touch input to the application and a user input via a user input module.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows three schematic diagrams in which removable input modules are attached around the periphery of a touch-screen device;

FIG. 2 is a flow diagram showing a computer implemented method of generating the mapping data for a touch-based computer game or other touch-based application;

FIG. 3 shows a schematic diagram of a first example system in which the method of FIG. 2 may be implemented;

FIG. 4 shows a schematic diagram of a second example system in which the method of FIG. 2 may be implemented;

FIG. 5 shows schematic diagrams of how such swipe data may be categorized;

FIG. 6 shows a schematic diagram of a third example system in which the method of FIG. 2 may be implemented;

FIG. 7 is a flow diagram showing how the mapping data generated by the method of FIG. 2 may be subsequently used;

FIG. 8 shows schematic diagrams of two example computing devices in which the method of FIG. 7 may be implemented;

FIG. 9 shows a schematic diagram of another example computing device in which elements of the methods of FIGS. 2 and 7 may be implemented; and

FIG. 10 illustrates an exemplary computing-based device in which embodiments of any of the methods described may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The embodiments described below are not limited to implementations which solve any or all of the disadvantages of known user input methods.

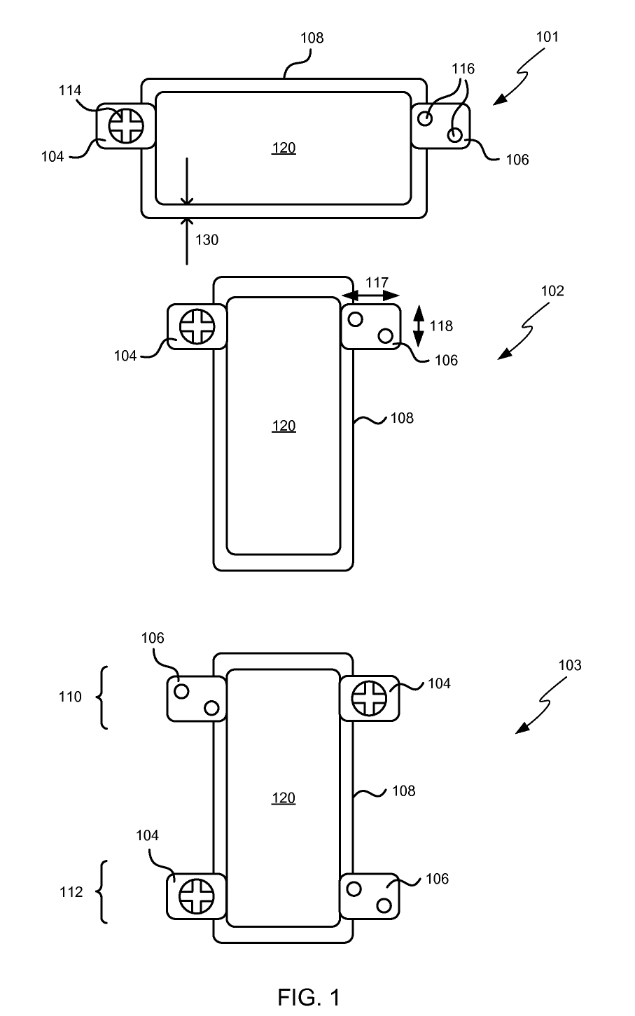

FIG. 1 shows three schematic diagrams 101-103 in which removable input modules 104, 106 are attached around the periphery of a touch-screen device 108 (i.e. around the edge of the display), which may, for example, be a portable or handheld device such as a tablet (of any size) or smartphone or a fixed touch-screen device (e.g. on an appliance or in a vehicle). In the first diagram 101, the touch-screen device 108 is oriented in landscape and one input module 104, 106 is attached on each of the short sides of the device (i.e. on the short sides of the face of the device which includes the display). In the second diagram 102, the touch-screen device 108 is in portrait orientation and the input modules 104, 106 are attached on the long sides of the device. In the third diagram 103, there are four input modules 104, 106 which are arranged at each end of the touch-screen device 108 and which may provide a pair of input modules 110 for use by a first user and a pair of input modules 112 for use by a second user, for example when playing a two player game on the touch-screen device 108. Alternatively, the four input modules in the third diagram 103 may be used by a single user.

Examples of touch-screen computing devices include mobile/handheld devices (e.g. smartphones, tablet computers, portable games consoles) and larger devices (e.g. large form-factor tablet computers, surface computing devices, a touch-sensitive device integrated into an appliance or vehicle, touch-sensitive televisions). Examples of touch-screen peripheral devices include touch-sensitive displays for desktop computers, a thin client tablet, a smart phone operating as a thin client display for a gaming console etc. While many of the following examples refer to a touch-screen computing device, this is by way of example. The examples may also be applied to a touch-screen peripheral device, in which case any data communication is between the input module and the computing device to which the touch-screen peripheral device is connected.

As shown by the three examples in FIG. 1, the removable input modules 104, 106 can be placed anywhere around the periphery of the touch-screen device 108 and may be rearranged by a user depending on the application displayed/running on the device, personal preference, or any other factor. Consequently, the modules may be described as reconfigurable (e.g. a user can choose where to place the modules and can move them if they wish). Although the examples in FIG. 1 show use of two and four modules, in other examples, a single module may be used or any other number of modules may be used by one or more concurrent users of the touch-screen device.

Each removable input module 104, 106 comprises an input control which may, for example, be a tactile input control, such as a physical control (e.g. one with a contoured profile which may move when pressure is applied by a user) which provides tactile feedback to a user that their finger or thumb is correctly positioned on the control. In other examples, the input control may not be tactile and instead may comprise an optical sensor, capacitive sensor or other sensor. In further examples, a combination of tactile and non-tactile input controls may be provided. It will be appreciated that the examples shown in FIG. 1 (a four-way control and a pair of buttons) are just examples of the input controls that may be provided on an input module. Further examples include, but are not limited to, a rotary knob, a slider, a single button (or different number of buttons), a switch and a small joystick. Examples of sensors which may be used include, but are not limited to, a hover sensor for hand position (e.g. based on reflecting IR or seeing IR shadows or thermal IR sensing or based on ultrasound), a magnetometer for sensing distortions due to rings worn on hands, or any other type of sensor that can detect a characteristic of the human (e.g. a galvanic skin response sensor or heart rate sensor) or a characteristic of something the human is wearing. If the device (e.g. the touch-screen device or the module) is flexible or articulatable, then the sensors may detect how the user flexes or articulates the device, e.g. using an accelerometer.

An input control 114, 116 may be mapped to a user input of an application (e.g. a computer game) displayed/running on the touch-screen device 108. The user input to which an input control 114, 116 is mapped may be a touch input (i.e. a user input that a user would usually provide by touching the touch-sensitive display) or may be an input via a physical button or control on the touch-screen device 108 or any input via a supported peripheral (e.g. a Bluetooth keyboard) or any other supported hardware (where the hardware need not be present but only be supported by the program receiving the user input). In some examples, the user inputs may be keystrokes such that the input/output modules may be used instead of an onscreen keyboard. In some examples the touch-based user input will be manipulation of traditional UI widgets like buttons, radio buttons, menus, sliders etc. and in some cases they will be gestures like pigtails or side-swipes.

Where there are multiple input controls, as in the examples shown in FIG. 1, each input control may be mapped to a different user input of the same application/program or the input controls may be mapped to user inputs of two or more applications/programs. In an example, both the four-way control 114 and buttons 116 may be mapped to user inputs of a game which is displayed or running on the touch-screen device. The mapping is described in more detail below.

In the examples shown in FIG. 1, the input control is on the front face of a module (i.e. on the face which is substantially parallel to the touch-screen display in use or when the module is attached to the device). Alternatively, an input control may be provided on another face of the module or a corner of the module in addition to, or instead of, an input control on the front face (e.g. to provide finger trigger buttons on a top side of a module and/or tactile controls on a rear surface of the display). For example, an input control may be provided on both the front and rear faces.

In various examples, one or more of the modules may also comprise an output device such as a visual indicator (e.g. a small display or one or more LEDs), audible indicator (e.g. a small speaker or buzzer or headphone socket), tactile (or haptic) feedback device (e.g. a vibration mechanism, any physical movement actuator or a movement retarder if the touch-screen device or module is flexible or articulatable) or other sensory feedback device (e.g. a heating or cooling device, such as a Peltier cooler, which can provide feedback by changing the temperature of a module or chemical outputs for smells, hormones, etc.).

When positioned around the periphery of a touch-screen device 108 (and physically attached to the touch-screen device), the input modules 104, 106 obscure little or none of the actual display area 120 and in the examples shown in FIG. 1, the modules 104, 106 do not obscure any of the actual display area 120 but instead only obscure the non-display border region (with a width labelled 130 in FIG. 1). This means that there is more real estate on the screen for viewing and increases ease of use.

It will be appreciated that FIG. 1 is not necessarily drawn to scale, however, in various examples the modules are compact and have dimensions (e.g. the length of a side of the front face, as indicated by arrows 117, 118) which are considerably smaller than the touch-screen device 108 to which they attach. For example, the front face of the modules may be approximately 1 inch (2.54 cm) square and used with touch-screen displays ranging from around 3 inches (˜7.5 cm) to 10 inches (˜25 cm) or more (where the screen size is measured on the diagonal). Although FIG. 1 shows all the modules being approximately the same shape and size, in some examples, the modules within a set may be of different sizes and/or shapes.

As described above, user inputs made via a removable input module (e.g. on a physical control on the removable input module) are mapped to a touch input to an application or other program being displayed on the touch-screen device using mapping data. Mapping data comprises data describing which touch input in an application, such as a computer game, a particular user input via a removable input module is mapped to, e.g. in the form of a plurality of data pairs which may be referred to as mappings.

The term ‘touch input’ is used herein to refer to the touch gesture which a user makes on the touch-screen device and which is an input to a game or application. Examples of touch inputs may include: swiping up, swiping down, pinch gestures, tapping in a particular location on the screen, etc. Touch inputs may be single touch inputs (e.g. swipe left with a single finger) or multi-touch inputs (e.g. a pinch gesture).

The term ‘touch event’ is used herein to describe when raw touch data is generated by the touch-screen device, i.e. when data describing the position on the touch-screen device that a user touches is generated. This touch event data may be time stamped or otherwise indexed so that the order of touch events (or their temporal relationship) can be determined. A touch input may be formed from one or more touch events. For example, a swipe left touch input is formed from a starting touch event (where the user initially contacts the touch-screen device), an ending touch event (where the user lifts their finger off the touch-screen device) and potentially a number of intermediate touch events between the starting and ending touch events.

Mapping data can therefore be used to emulate touch events (and hence touch input) as a result of interactions by a user with a removable input module (or set of removable input modules). The mapping may, in various examples, be considered to be bi-directional in that an interaction via a removable input module maps to a touch input and a touch input maps to an interaction via a removable input module. Any reference below which refers to mapping A to B may alternatively be described as a mapping from A to B or a mapping from B to A.

The mapping data may be generated manually by the game or application designer when creating the game or application and provided to a user along with the game or with the removable input module. However, for legacy games or applications (i.e. games or applications which were created prior to the development of the removable input module) or games or applications which were created without any consideration of the removable input module, such mapping data is not available. The lack of mapping data prevents a user from controlling such a game or application using a removable input module unless they create the mapping data themselves, which is a time-consuming and potentially error-prone activity. Furthermore, for games where the touch inputs are not clearly defined and documented (but instead the interaction is more intuitive or free-form) it may be very difficult for a user to manually create the mapping data. For such games or applications with intuitive or free-form interaction, it may even be hard for a developer of the game or application to predict which touch gestures are going to be the most popular or effective and therefore the ones which should be mapped to inputs via a removable input module.

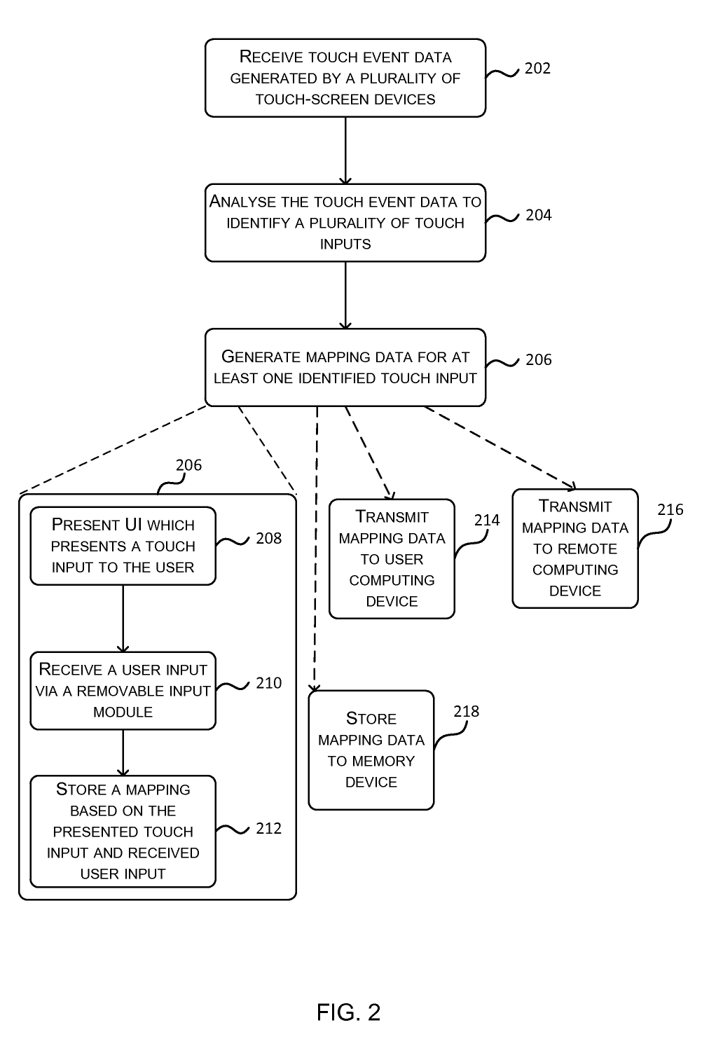

FIG. 2 is a flow diagram showing a computer implemented method of generating the mapping data for a touch-based computer game or other touch-based application. The term ‘touch-based’ is used herein to refer to a game or application which is operated predominantly (or entirely) through touch inputs made by a user on a touch-screen device. These touch-based applications or games include ‘touch-only’ applications or games which only use touch inputs, ‘touch-first’ applications or games which are primarily designed for touch input but do have keyboard or other input support (e.g. via a physical control) and other applications or games that use any combination of touch inputs and inputs via physical controls.

A lot of games and other applications which are currently available on application stores/marketplaces (e.g. the Windows® Store) for download onto smartphones and/or tablets are entirely touch-based (and so may be referred to as ‘touch-only’ games or applications). Some of these games or applications provide on-screen controls (e.g. soft buttons, soft joysticks, soft keyboards) which define a precise location where touch inputs need to be made (and hence mimic a physical control) and/or on-screen menus similar to a non-touch pointer based interface (e.g. which uses a mouse as the user input device). Some games (and other applications, e.g. drawing applications), however, allow a more loosely defined or free-form touch-based interface for at least a part of the game play in which the target positions for touch inputs are not specifically identified within the graphical user interface. An example of such a game is ‘Subway Surfers’ published by Kiloo in which a user can swipe up anywhere on the screen to cause the avatar to jump and a user may swipe left or right at any vertical position on the screen to cause the avatar to move to the left or right.

In the following description, some of the methods and examples are described with reference to generating mapping data for a game. This is by way of example, and the methods and examples may also relate to applications which are not games, such as mapping applications (e.g. manipulating an on-screen map), drawing applications, image viewing or editing applications, applications where users navigate through a series of options (e.g. using swipes), music applications (e.g. manipulating an audio output, selecting tracks), etc.

As shown in FIG. 2, the method comprises receiving touch event data generated when one or more users are interacting with a touch-based application such as a touch-based computer game (block 202) and in various examples a touch-only game. As described above, a touch-based computer game is described by way of example only and the method is also applicable to other touch-based applications (including non-game applications).

The touch event data which is received comprises lots of examples of touch event data for the particular touch-based application and this may include lots of examples for each of several different modes within the application where the application has different modes of use. In many examples, the touch event data which is received (in block 202) is generated by a plurality of users interacting with the application and/or generated by a plurality of touch-screen devices (where these devices may be the same type of device or different types of devices).

The touch event data which is received (in block 202) is analyzed to identify a plurality of touch inputs to the game (block 204) and this analysis is performed independently of code for the game. Mapping data is then generated (block 206), where the mapping data identifies at least one mapping between an identified touch input to the game (from block 204) and a user input via a removable input module (e.g. an input module 104, 106 as shown in FIG. 1).

In various examples, the mapping data may map all the identified touch inputs to user inputs via a removable input module (e.g. where different touch inputs are mapped to different user inputs and the user inputs may be on one or more removable input modules). In other examples, the mapping data may only map a (proper) subset of the identified touch inputs to user inputs via a removable input module and the remaining, unmapped, identified touch inputs may remain as touch-only inputs. Where only a subset of the identified touch inputs are mapped, a user playing the application (e.g. game) will use a combination of user inputs via one or more removable input modules and touch inputs to interact with the application or game.

The method of FIG. 2 may be implemented by a centralized computing device, such as a server within a data center (e.g. a ‘cloud-based’ computing device). Alternatively the method may be implemented across a plurality of computing devices which may be distributed across a network (e.g. located in different data centers). The game or application may run on the touch-screen devices which generate the touch event data (received in block 202), or for peripheral touch-screen devices on the associated computing device, or the game or application may run on a separate computing device which is remote from the touch-screen device (e.g. on a server in a data center) with the graphical user interface (GUI) for the game or application being rendered on the touch-screen device (which may be a touch-screen computing device or a peripheral touch-screen device).

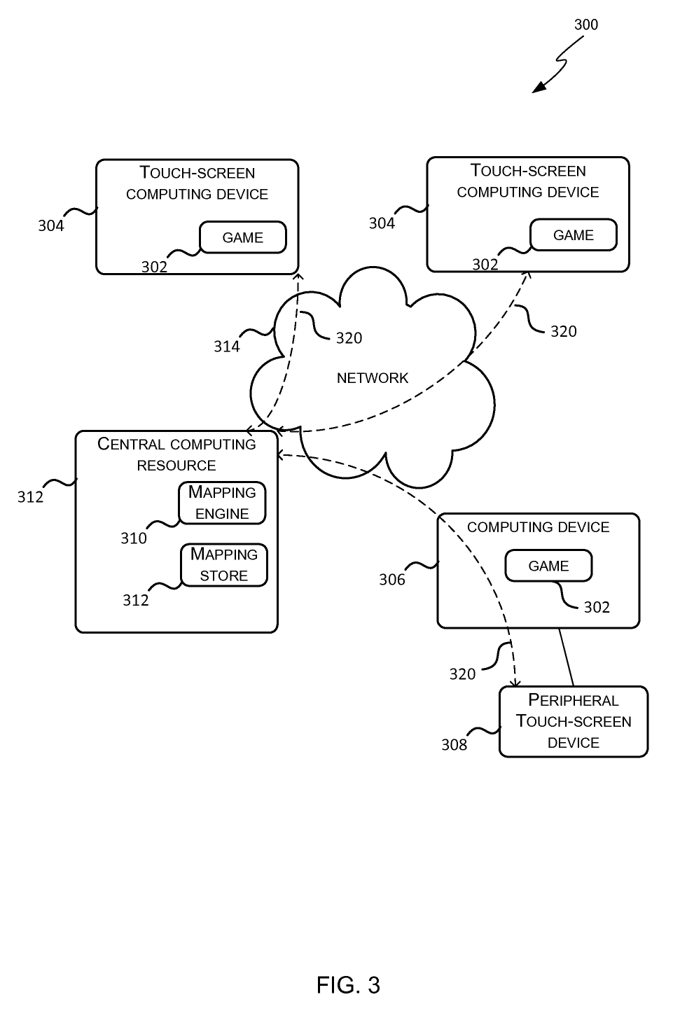

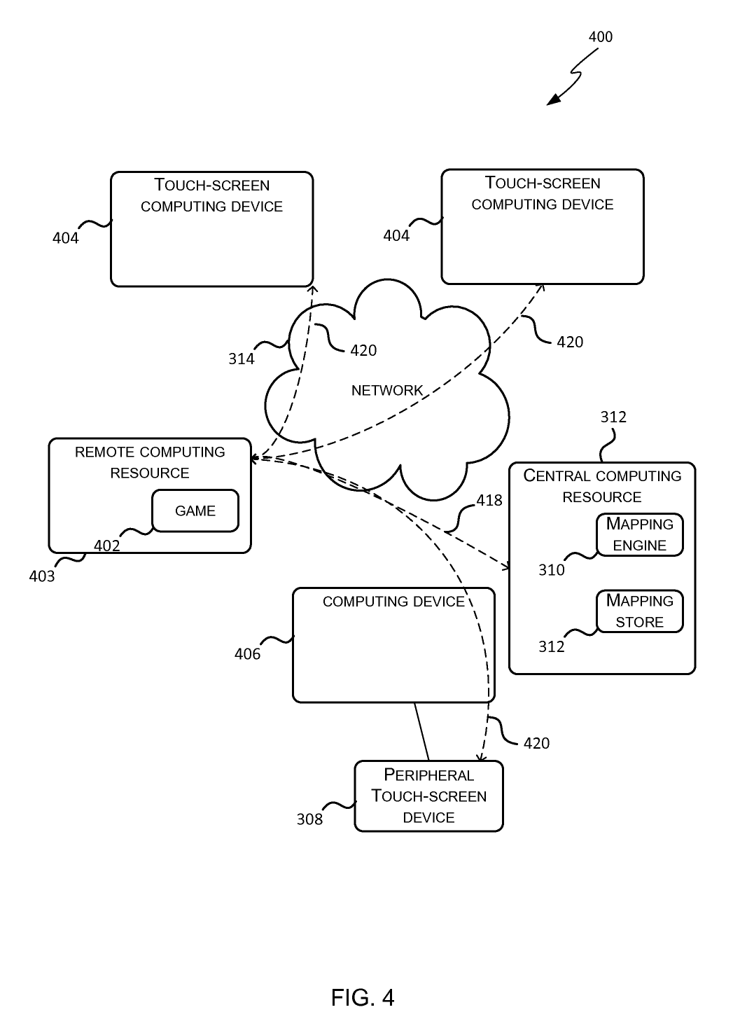

FIGS. 3 and 4 show schematic diagrams of example systems in which the methods of generating mapping data as described herein (e.g. as shown in FIG. 2 and described above) may be implemented. In the system 300 shown in FIG. 3, the game 302 runs on the user computing devices, i.e. the touch-screen computing device 304 or the computing device 306 to which a peripheral touch-screen device 308 is connected. In the system 400 shown in FIG. 4, the game 402 runs on a remote computing resource 403 (i.e. a computing device which is remote from the user computing devices) and a GUI for the game 402 is rendered on the touch-screen devices, e.g. a touch-screen computing device 404 or a computing device 406 to which a peripheral touch-screen device 308 is connected.

Although FIGS. 3 and 4 show two separate systems, one in which the game runs locally (system 300) and one in which the game runs remotely (system 400), it will be appreciated that in some systems there may be some user computing devices which run the game locally (i.e. on the user computing device) and others which display the GUI of a game which runs remotely.

In both systems 300, 400, a mapping engine 310 which implements the method of FIG. 2 runs on a central computing resource 312 and receives touch event data generated by a plurality of touch-screen devices 304, 308, 404. The computing devices in the systems 300, 400 are interconnected by a network 314 or any other arrangement of communication links (e.g. point to point links between computing devices). As indicated by the dotted arrows 320, in the first system 300, the central computing resource 312 receives the touch event data (in block 202) from the touch-screen computing devices 304 or the computing device 306 which has a peripheral touch-screen device 308. In the second system 400, as indicated by the dotted arrow 418, the touch event data is instead received (in block 202) from the remote computing device 403 which runs the game 404 and the remote computing device 403 receives the touch event data from the touch-screen computing devices 404 or the computing device 406 which has a peripheral touch-screen device 408 (as indicated by the dotted arrows 420). Although FIG. 4 shows a single remote computing resource 403 running the game 404, it will be appreciated that there may be many remote computing resources 403 running the game 404 and the central computing resource 312 which comprises the mapping engine 310 may receive touch event data (in block 202) from multiple remote computing resources. Having generated the mapping data, the mapping engine 310 may store the mapping data in a mapping store 312.

Although FIGS. 3 and 4 show a single central computing resource 312 which runs the mapping engine 310, it will be appreciated that in other examples, the mapping engine 310 may be run on (or across) multiple central computing resources 312 and these central computing resources 312 may operate independently (i.e. they each perform the method of FIG. 2 and do not share touch event data or mapping data) or collaboratively (i.e. they each perform some or all of the method of FIG. 2 and they share at least some touch event data and/or mapping data).

Although in FIG. 4 the central computing resource 312 which runs the mapping engine 310 and the remote computing resource 403 which runs the game 402 are shown as separate entities, in some examples, they may be a single computing resource which runs both the game 402 and the mapping engine 310. However, as described above, the mapping engine 310 performs the analysis of the touch event data independently of the code for the game, i.e. the game 402 and the mapping engine 310 are independent pieces of code with the mapping engine 310 operating on touch event data which may be received from the game 402 but without inspecting the code for the game.

The analysis of the touch event data to identify a plurality of touch inputs (in block 204) may involve categorizing or clustering the touch event data to identify touch actions which are performed a large number of times (e.g. using heuristics or machine learning). For example, the touch event data received which describes a user swiping across the touch-screen device (e.g. a prolonged touch event where the user moves their finger from a start point to an end point which is not the same as the start point) may be categorized according to the approximate start point and the direction of the swipe.

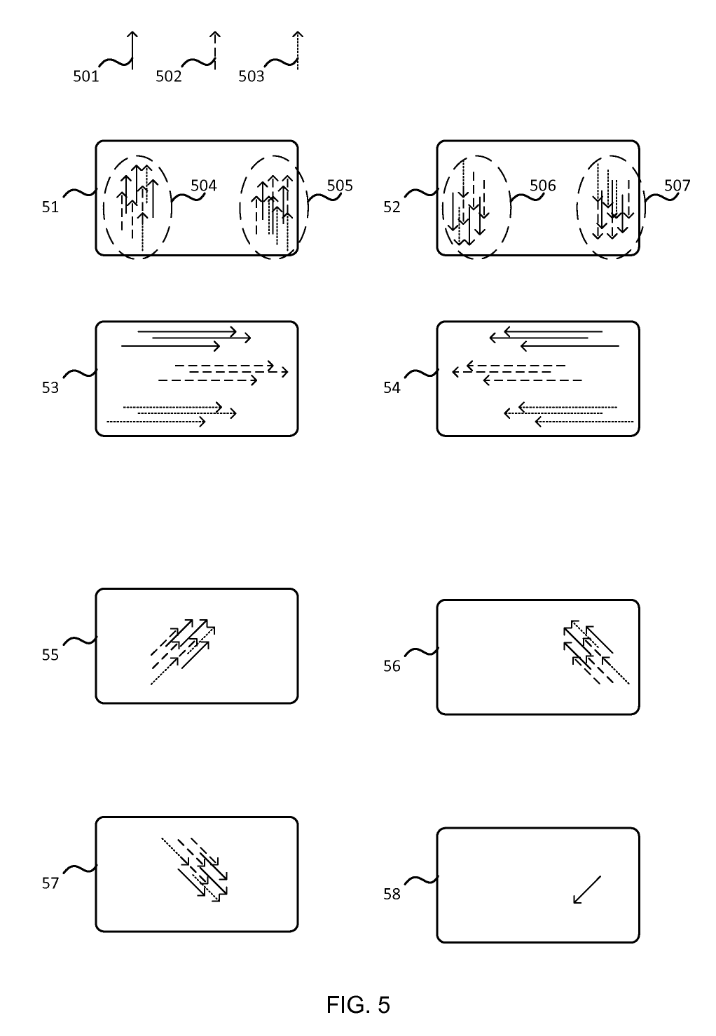

FIG. 5 shows schematic diagrams of how such swipe data may be categorized in which three different arrow styles (solid 501, dashed 502 and dotted 503) are used to indicate swipe data that was generated by three different touch-screen devices when the same game was being played.

A first category 51 of swipe data comprises swipes which start in the bottom half of the touch-screen device and move upwards (or approximately upwards) and a second category 52 of swipe data comprises swipes which start in the top half of the touch-screen device and move downwards (or approximately downwards). In both these categories, the swipe data generated by each touch-screen device comprises two distinct clusters of swipes (marked by dotted outlines 504-507), one on each side of the touch-screen device and so from these two categories, four touch inputs may be identified for the particular game: swipe up on the left (cluster 504), swipe up on the right (cluster 505), swipe down on the left (cluster 506) and swipe down on the right (cluster 507).

A third category 53 of swipe data comprises swipes which start in the left half of the touch-screen device and move to the right (or approximately to the right) and a fourth category 54 of swipe data comprises swipes which start in the right half of the touch-screen device and move to the left (or approximately to the left). In both these categories, the swipe data received is clustered according to the touch-screen device on which it was generated. As all the swipe data corresponds to the same game, it can therefore be concluded that the swipes in a particular direction (e.g. to the left or to the right) are all equivalent as far as the game is concerned and so from these two categories, two touch inputs may be identified for the particular game: swipe right (at any vertical position on the touch-screen device) and swipe left (at any vertical position on the touch-screen device).

Similar analysis may be performed based on the other four categories 55-58 which show diagonal swipes and from which three touch inputs may be identified—one each from categories 55-57: diagonally upwards from left to right (category 55), diagonally upwards from right to left (category 56) and diagonally downwards from left to right (category 57). In the case of the last category in this example, which comprises swipes diagonally downwards from right to left, only a single swipe was categorized in this way and so the analysis may decide to discard this swipe as potentially being an erroneous user input.

It will be appreciated that where categorization is used (e.g. as shown in FIG. 5), many swipes will not fit exactly into any category. In performing categorization, a swipe may be allocated to its closest category. In the event that a swipe is not similar to any category, it may be discarded or processed separately (e.g. a new category may be added to the list of categories used in categorization).

When performing categorization, this may be performed independent of the orientation of the touch-screen device (e.g. portrait or landscape orientation) or different categories may be defined dependent on the orientation of the touch-screen device when the touch event data was generated (e.g. a vertical swipe on device in portrait orientation may not necessarily result in the same action within the game as the same action on a device in landscape orientation).

In examples where the touch event data is generated by a plurality of touch-screen devices, it is likely to be generated based on game play by a plurality of users and so the touch inputs identified are more likely to be a complete set and include different styles of game play and different user preferences. This has the effect of improving the quality of the mapping data which is generated (in block 206), particularly when used in combination with a machine learning algorithm, as part of a reinforcement learning system. To preserve user privacy, the touch event data which is analyzed may be anonymized such that the mapping engine knows that different sets of data originate from different touch-screen devices, but has no information relating to identity from any touch-screen device which generated a set of touch event data (e.g. no information about the identity of a particular user, device, data entered into an application, etc.).

In further examples, the analysis of the touch event data (in block 204) may use machine learning and/or pixel data from the game. Where pixel data is used, this pixel data may be stored by the touch-screen computing device 304, 404 (e.g. by an application running on the touch-screen computing device which communicates with the mapping engine 310), by the computing device 306, 406 connected to a peripheral touch-screen device 308 (e.g. by an application running on the computing device which communicates with the mapping engine 310) or by the remote computing resource 403. The pixel data may be communicated to the mapping engine along with the touch event data (and received in block 202) and again, to preserve privacy, the pixel data may be anonymized such that the mapping engine has no information relating to identity from any touch-screen device which generated a set of pixel data and touch event data. As described above, even where pixel data is used, the analysis is performed (in block 204) independently of the code for the game.

In an example which uses pixel data, the pixels in each frame generated during the course of gameplay (or interaction with an application) may be analyzed to determine what happens on screen as a result of any particular touch input. There may be on-going pixel activity independent of touch input, but nonetheless it should be possible to detect which changes are correlated to touch inputs. For example, in Subway Surfers the scene is continually rolling towards the avatar (to simulate the avatar running along the train tracks) but in addition to this side-swipes will cause the avatar to move left or right. Detecting this could be useful in generating the right set of mappings—both making sure that a suitable physical control is used to drive the mapping, and also to generate the correct number of mappings. For example, if users predominantly side-swipe at two different heights on the screen, these might create two separate clusters of swipe data; however, analysis of the pixel data would indicate that irrespective of how high the side-swipe is it always has the same effect in the game. Consequently, the two clusters of swipe data can be combined (i.e. there is one unique gesture and not two) and only one mapping is needed.

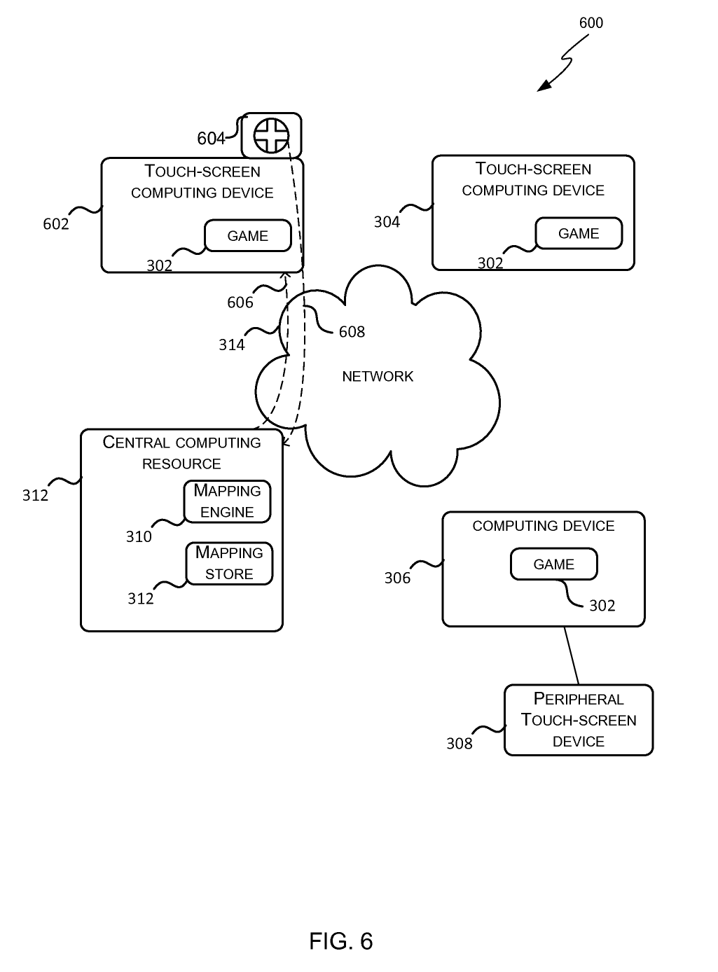

Having identified one or more touch inputs for the game (in block 204), at least one identified touch input is mapped to (or mapped from) an input on a removable input module and this mapping is stored as part of the mapping data (in block 206), e.g. in mapping store 312. It will be appreciated that generating the mapping data (in block 206) may, for example, comprise automatically allocating an input on a removable input module to an identified touch input, e.g. by automatically selecting an input from a set of candidate inputs without any user input. In other examples, the mapping data may be generated with some involvement of the user (e.g. such that different users may have different mappings) and one example is shown in FIGS. 2 and 6. In the example shown in FIGS. 2 and 6, mapping data is generated by presenting a UI which presents (i.e. shows) a touch input to the user (block 208) and in the example shown, this UI is rendered on a touch-screen device 602 (e.g. with UI data being provided to the touch-screen device 602 as indicated by dotted arrow 606). Generating the mapping data further comprises receiving user input (block 210, e.g. via a removable input module 604 attached to the touch-screen device 602, as indicated by arrow 608 or via the touch-screen device itself or via a keyboard or mouse) and storing a mapping based on the presented touch input and the received user input (block 212), e.g. in mapping store 312.

For example, the UI may display the words ‘Swipe left’ or a graphical representation (e.g. a finger and arrow) of a swipe to the left (in block 208) or give an equivalent audio prompt (e.g. “Press the controller you want to use to move the game character left”), where a swipe to the left is one of the identified touch inputs (from block 204) and in response a user may press a button or other input device on a removable input module. A user input signal (i.e. data which identifies the user input made by the user via the removable input module) is transmitted to the mapping engine 310 (and is received in block 210, as indicated by dotted arrow 608). The mapping engine 310 then stores a mapping between the ‘swipe left’ touch input and the user input identified in the user input signal (in block 212), e.g. in mapping store 312.

In another example, the UI may display more than one identified touch input to the user (in block 208) and in response a user may perform one of the presented touch inputs (e.g. they may swipe upwards on the touch-screen device) and make a user input on the removable input module. The user input signal (received in block 210, as indicated by dotted arrow 608) will, in this example, identify two user inputs—a touch input and an input via the removable input module. The mapping engine then stores a mapping between the two identified user inputs (in block 212), e.g. in mapping store 312.

In a further example, the UI may display more than one identified touch input to the user (in block 208) and in response a user may select one of the presented touch inputs and make a user input on the removable input module. The user input signal (received in block 210, as indicated by dotted arrow 608) will, in this example, identify two user inputs—the selected touch input and an input via the removable input module. The mapping engine then stores a mapping between the two identified user inputs (in block 212), e.g. in mapping store 312.

In various of these examples, the UI may display several mappings on-screen at the same time to enable the user to make a choice about one mapping in the context of a larger set of touch inputs (rather than setting the mappings one at a time). For example, a user may realize that they do not want to map left and right D-pad buttons to swipe-left and swipe-right if they can see that the D-pad is better used for touch events on a virtual joystick.

In another example, a user may start by activating the physical control they want to create a mapping for and have the UI present different options for the touch input which would be emulated. This could be a complete list of all identified touch events, or it could be the list of ‘as yet un-mapped’ touch events, or it could be a list of touch events which are considered good candidates according to an algorithm which either looks at hard-coded heuristic relationships between physical controls and likely touch inputs or which uses machine learning of the controls people typically associate with particular touch inputs.

In yet another example, a likely set of mappings could be crowd-sourced based on which controls people typically use for different types of touch input gestures. These mappings could be presented one-at-a-time to the user so that the user can accept the suggestion or modify it, or alternatively multiple mappings may be displayed simultaneously.

Although for some games which provide soft controls (e.g. on-screen buttons or joysticks) there may be an intuitive one-to-one mapping between the touch input and an input on a removable input module (e.g. an on-screen button press is mapped to a button press on the removable input module), this is not true for the more loosely defined or free-form touch inputs (e.g. swipes in ‘Subway Surfers’). The methods described herein can accommodate both types of games—those with on-screen controls and those with more free-form input styles.

FIG. 6 which is described above shows a system which corresponds to that shown in FIG. 3. This is by way of example only and in other examples, the system may correspond to that shown in FIG. 4.

The mapping data which is generated by the mapping engine 310 (in block 206) may be transmitted to the user computing device (block 214), e.g. the touch-screen computing device 304, 404 or to the computing device 306, 406 to which a peripheral touch-screen device 308 is connected, irrespective of whether the user computing device runs the game (as in the system 300 of FIG. 3) or does not (as in the system 400 of FIG. 4). Alternatively, the mapping data may be transmitted to the remote computing resource 403 which runs the game 402 (block 216). Consequently, any of the touch-screen computing devices 304, 404, 602, the computing device 306, 406 to which a peripheral touch-screen device 308 is connected or the remote computing resource 403 may also comprise a mapping store (not shown in FIGS. 3, 4 and 6). In other examples, instead of transmitting the mapping data to another computing device (in block 214 or 216), the mapping data may be written to a memory device (block 218), where the memory device may be a memory card or stick, a memory within an NFC tag, etc.

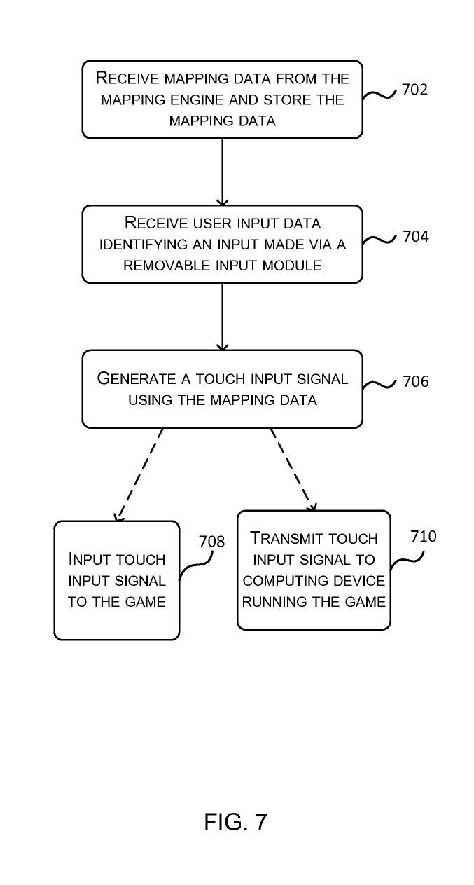

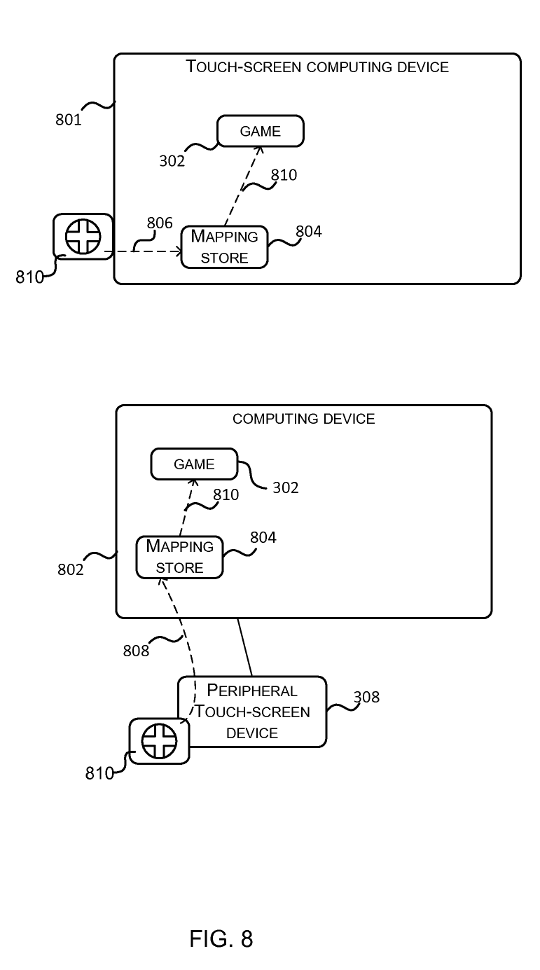

FIG. 7 is a flow diagram showing how the mapping data may be subsequently used and this can be described with reference to FIG. 8 which shows two example computing devices 801, 802. The first example computing device 801 is a touch-screen computing device (e.g. like devices 304, 404, 602 described above) and the second example computing device 802 is not a touch-screen computing device but has a peripheral touch-screen device 308 connected to it (e.g. like devices 306, 406 described above). The computing device 801, 802 which receives the mapping data (as transmitted in block 214 or 216 or as downloaded from the memory device to which the mapping data was stored in block 218) stores the mapping data in a mapping store 804 (block 702). Subsequently user input data may be received which relates to the same game as the mapping data (block 704, arrows 806, 808), where the user input data identifies a user input made via a removable input module 810. In response to receiving the user input data, the computing device generates a touch input signal for the game using the mapping data from mapping store 804 (block 706), e.g. the computing device finds the data pair within the mapping data which includes the user input identified in the user input data received and generates a signal for the touch input in the data pair. Where the computing device also runs the game, the touch input signal may be input directly to the game (block 708, arrows 810). If, however, the computing device does not run the game (e.g. if the computing device is a user computing device 404, 406 in the system 400 of FIG. 4), then the computing device transmits the touch input signal to the computing device which is running the game (block 710).

In various examples, the mapping engine 310 may run on the same computing device as the game 402, e.g. the remote computing resource 403 and the central computing resource 312 in FIG. 4 may be the same computing device.

In a system where the mapping engine 310 runs on the same computing device as the game 402, the mapping data (generated in block 206) may not be transmitted to another device (e.g. computing device or memory device) but instead may just be stored on the computing device (e.g. remote computing resource 403 in FIG. 4). When user input data is subsequently received which relates to the same game as the mapping data (block 704), the user input data identifying a user input made via a removable input module, the computing device generates a touch input signal for the game using the mapping data (block 706) and inputs the touch input signal into the game (block 708).

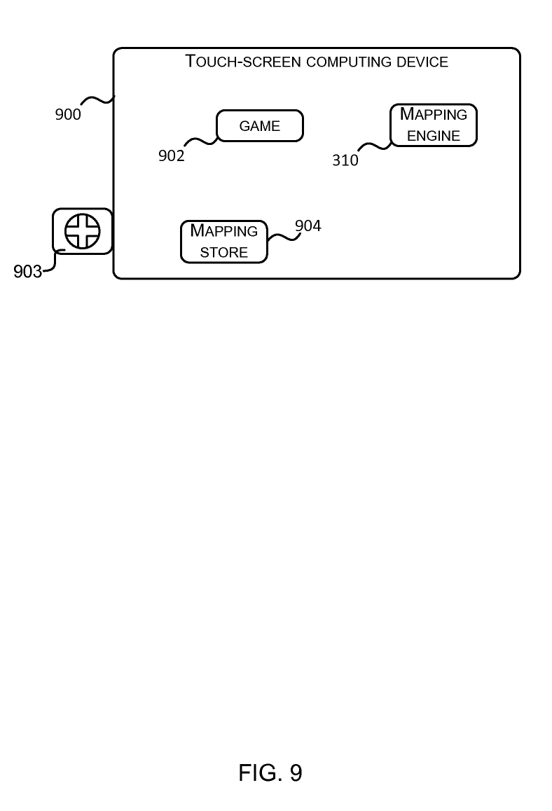

In further examples, the mapping engine 310 may run on a touch-screen computing device 900, as shown in FIG. 9. Such a computing device may implement the methods of both FIGS. 2 and 7.

In a ‘generating’ or ‘training’ mode, the touch-screen computing device 900 implements the method shown in FIG. 2 and described above. In this first mode of operation, the mapping engine 310 receives touch event data generated when one or more users are interacting with a touch-based application such as a touch-based computer game 902 (block 202) running on the touch-screen computing device 900. In various examples, the touch-screen computing device 900 may also receive touch event data (in block 202) generated by users interacting with a game which is the same as game 902 and which is running on another computing device (e.g. via a peer to peer system or centralized computing resource which distributes touch event data). The touch event data which is received (in block 202) is analyzed to identify a plurality of touch inputs to the game (block 204) and this analysis is performed independently of code for the game 902. Mapping data is then generated (block 206) by the mapping engine 310, where the mapping data identifies at least one mapping between an identified touch input to the game (from block 204) and a user input via a removable input module 903. The mapping data which is generated (in block 206) is stored in mapping store 904.

In a ‘use’ mode, the touch-screen computing device 900 implements the method shown in FIG. 7 and described above. In this second mode of operation, when user input is received via the removable input module 903 which relates to the same game as the mapping data, e.g. game 902 (block 704), the computing device generates a touch input signal for the game using the mapping data from mapping store 904 (block 706), e.g. the computing device 900 finds the data pair within the mapping data (in mapping store 904) which includes the user input identified in the user input data received and generates a signal for the touch input in the data pair. The touch input signal is then input directly to the game 902 (block 708).

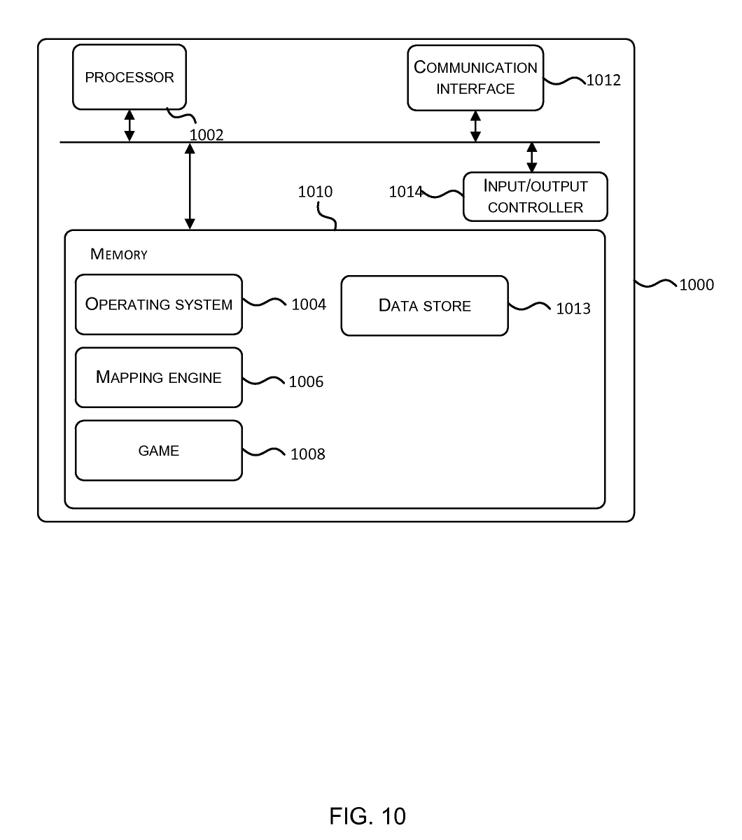

FIG. 10 illustrates various components of an exemplary computing-based device 1000 which may be implemented as any form of a computing and/or electronic device, and which may implement either or both of the methods shown in FIGS. 2 and 7 and described above. This computing-based device 1000 may therefore be a user computing device 304, 306, 404, 406, 602, 801, 802, 900, a central computing resource 312 or a remote computing resource 403 as shown in the systems 300, 400, 600 in FIGS. 3, 4 and 6 and in FIGS. 8 and 9.

Computing-based device 1000 comprises one or more processors 1002 which may be microprocessors, controllers or any other suitable type of processors for processing computer executable instructions to control the operation of the device in order to generate or use mapping data (as in the method of FIGS. 2 and/or 7). In some examples, for example where a system on a chip architecture is used, the processors 1002 may include one or more fixed function blocks (also referred to as accelerators) which implement a part of the method of generating/using mapping data in hardware (rather than software or firmware). Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

Platform software comprising an operating system 1004 or any other suitable platform software may be provided at the computing-based device to enable application software such as the mapping engine 1006 and/or the game 1008 to be executed on the device.

The computer executable instructions may be provided using any computer-readable media that is accessible by computing based device 1000. Computer-readable media may include, for example, computer storage media such as memory 1010 and communications media. Computer storage media, such as memory 1010, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1010) is shown within the computing-based device 1000 it will be appreciated that the storage may be distributed or located remotely and accessed via a network or other communication link (e.g. using communication interface 1012).

The communication interface 1012 may use any suitable communications protocol (e.g. a wired or wireless protocol) to communicate with other computing devices. Depending on whether the computing-based device 1000 is a user computing device 304, 306, 404, 406, 602, 801, 802, 900, a central computing resource 312 or a remote computing resource 403 (e.g. as shown in the systems 300, 400, 600 in FIGS. 3, 4 and 6 or in FIGS. 8 and 9), the communication interface 1012 may be used to communicate or receive mapping data, touch event data, user input data, etc.

As well as storing computer executable code for the mapping engine 1006 and/or the game 1008, the memory 1010 may also be used to store mapping data (in data store 1013) which may have been generated on the device 1000 (by the mapping engine 1006) or generated on another computing device and received via the communication interface 1012.

The computing-based device 1000 may also comprise an input/output controller 1014 arranged to output display information to a display device which may be separate from or integral to the computing-based device 1000. The display information may provide a graphical user interface (e.g. the UI which is generated in block 208). The input/output controller 1014 is also arranged to receive and process input from one or more devices, such as a user input device (e.g. a removable input module, mouse, keyboard, camera, microphone or other sensor). In some examples the user input device may detect voice input, user gestures or other user actions and may provide a natural user interface (NUI). This user input may, for example, be used in the generation of mapping data (e.g. in block 210). Where the computing-based device 1000 is a touch-screen computing device (e.g. touch-screen computing device 304), the display device may also act as the user input device. The input/output controller 1014 may also output data to devices other than the display device, e.g. a locally connected printing device.

Any of the input/output controller 1014, display device and the user input device may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although the present examples are described and illustrated herein as being implemented in systems as shown in FIGS. 3, 4 and 6, the systems described are provided as examples and not limitations. As those skilled in the art will appreciate, the present examples are suitable for application in a variety of different types of systems which may, for example, combine aspects of any of FIGS. 3, 4 and 6 (e.g. some user devices may run the game and others may display the GUI of a game which is run remotely). For example, although FIGS. 3, 4 and 6 show a centralized resource 312 which runs the mapping engine 310 in other examples, this centralized resource 312 may be a user computing device (e.g. as shown in FIG. 9) which receives touch event data from a plurality of other devices (e.g. using a peer-to-peer system) or which only collects locally generated touch event data.

Although the examples above are described as generating mapping data for a removable input module (i.e. the mapping data comprises data describing which touch input in an application, such as a computer game, a particular user input via a removable input module is mapped to), the methods described herein may also be applied to other user input modules and not just to removable input modules. For example, the methods may be applied to user input devices that cannot be attached to a touch-screen device and examples include, but are not limited to, depth cameras, gloves or other types of wearable devices, clothing with embedded sensors (e.g. a shoe with a touch or pressure sensor integrated into the sole), etc. For example, a touch input of a user tapping a screen may be mapped to a pressure sensor in a shoe, such that when the user who is wearing the shoe stamps their foot, an alien bug is squashed in a touch-based computer game. The methods are not limited to user input devices which require user motion (e.g. pressing a button) and may instead use other types of sensory inputs (e.g. speech input).

Furthermore, although many of the examples are described in terms of generating mapping data for a game, the methods described herein may be used for other types of applications in addition to, or instead of, computer games.

As described above, the methods described herein enable the use of removable input modules (such as shown in FIG. 1) with legacy and/or touch-only games. It is not necessary to analyze the code for the game or re-write the game code in any way but instead the mapping data is generated by analyzing the touch events generated by many users playing the game. As the analysis (which may be processor-intensive) is performed on a centralized computing resource, it does not negatively affect the processing or battery life of the user computing device which, in the case of a portable user computing device (e.g. smartphone or tablet computer) may be resource constrained in terms of battery life and/or processing power.

By using data generated by many users, a user that has not played the game before can receive mapping data (e.g. along with the game code or the removable input modules) and does not need to play the game first to generate the mapping data. Furthermore, by using data from many users playing the game, the data is more representative of the entire user population, rather than just reflecting the way that one or two users choose to play a game (e.g. particularly where a game allows some more free-form or loosely defined touch inputs).

The methods described herein may be used to make touch-based applications (e.g. touch-based computer games) accessible to everyone. For example, where a user cannot interact with a touch-based application using their fingers, the touch inputs may be mapped to inputs made via a user input device which the user can operate with another part of their body.

In the examples described above, the mapping data is generated based on touch event data generated by users interacting with the touch-based application. For new games or applications which have not been used such touch event data does not exist. However, the methods described herein may be adapted to use mapping data from a similar type of application (e.g. for an existing game or application of a similar type) to provide mapping data for at least some of the touch events in the application. For example, the centralized resource may generate some generic mapping data sets for different types of application or game (e.g. generic mapping data for first person shooter games, generic mapping data for drawing applications, etc.).

A first further example provides a method comprising: receiving, at a computing resource, touch event data resulting from users interacting with a touch-based application; analyzing the touch event data to identify a plurality of touch inputs to the touch-based application, wherein the analysis is performed independently of code for the application; and generating mapping data, the mapping data identifying at least one mapping between an identified touch input to the application and a user input via a user input module.

In the first further example, the method may further comprise: transmitting the mapping data to a user computing device.

In the first further example, the method may further comprise: transmitting the mapping data to a computing device which runs the touch-based application. The computing device may be in a data center.

In the first further example, the user computing device may be a touch-based computing device and wherein the touch-based computing device runs the touch-based application.

In the first further example, the method may further comprise: receiving user input data from a touch-screen device, the user input data identifying a user input made via a removable input module; and generating a touch input signal using the mapping data.

A second further example provides a method comprising: receiving, at a computing resource, touch event data resulting from users interacting with a touch-based application; analyzing the touch event data to identify a plurality of touch inputs to the touch-based application, wherein the analysis is performed independently of code for the application; and generating mapping data, the mapping data identifying at least one mapping between an identified touch input to the application and a user input via a user input module; and transmitting the mapping data to a computing device which runs the touch-based application, wherein the mapping data is used by the computing device to generate a touch input signal for the touch-based application in response to a user input made via a user input module.

In the second further example, the method may further comprise: receiving user input data at the computing device, the user input data identifying a user input made via a user input module; and generating a touch input signal using the mapping data.

In the first or second further examples, the user input module may be a removable input module.

In the first or second further examples, the computing device may be a user computing device, such as a touch-based user computing device, or a centralized computing resource, such as a computing device in a data center

In the first or second further examples, the mapping data may identify at least one mapping between an identified touch input to the application and a user input via a physical control on a user input module.

In the first further example, analyzing the touch event data to identify a plurality of touch inputs to the touch-based application may comprise: categorizing the touch event data based on a start touch event and at least one subsequent touch event; and identifying clusters within the categorized touch event data.

In the first or second further examples, generating mapping data may comprise: receiving user input data in response to a touch-screen device displaying a UI presenting a touch input to the user; and storing a mapping based on the presented touch input and the received user input data.

In the first or second further examples, the method may further comprise: writing the mapping data to a memory device.

A third further example provides a method comprising: transmitting touch event data resulting from users interacting with a touch-based application from a first centralized computing resource running the touch-based application to a second centralized computing resource running a mapping engine; receiving, from the second centralized computing resource, mapping data generated by the mapping engine, the mapping data identifying at least one mapping between an identified touch input to the application and a user input via a removable input module; receiving user input data identifying an input made via a removable input module; generating a touch input signal based at least in part on the user input data and the mapping data; and inputting the touch input signal to the game.

In the third further example, the touch event data may be generated by a plurality of touch-screen devices.

In the third further example, the mapping data may be generated independently of code for the application.

In the third further example, the touch-based application may be a game comprising at least one touch input which can be performed at a plurality of different positions on a touch-screen device.

In the third further example, the touch-based application is a touch-based game.

A fourth further example provides a computing device comprising: an interface configured to receive touch event data resulting from users interacting with a touch-based application; a processor; and a memory, wherein the memory is arranged to store computer executable instructions which, when executed, cause the processor to: analyze the touch event data to identify a plurality of touch inputs to the game, wherein the analysis is performed independently of code for the application; and generate mapping data, the mapping data identifying at least one mapping between an identified touch input to the application and a user input via a user input module.

In the fourth further example, the user input module may be a removable input module.

In the fourth further example, the interface may be a communication interface.

In the fourth further example, the interface may be a communication interface and the memory may be further arranged to store computer executable instructions which, when executed, cause the processor to: transmit the mapping data to a user computing device via the communication interface.

In the fourth further example, the interface may be a communication interface and the memory may be further arranged to store computer executable instructions which, when executed, cause the processor to: transmit the mapping data to a computing device via the communication interface, wherein the computing device in the data center runs the touch-based application. The computing device may be in a data center.

In the fourth further example, the memory may be further arranged to store computer executable instructions which, when executed, cause the processor to: receive user input data from a touch-screen device, the user input data identifying a user input made via a user input module; generate a touch input signal using the mapping data; and input the touch input signal to the touch-based application. The user input module may be a removable input module.

In the fourth further example, the user computing device may be a touch-based computing device and the touch-based computing device runs the touch-based application.

A fifth further example provides a system comprising a first computing device, the first computing device comprising: a communication interface configured to receive touch event data generated by a plurality of touch-screen devices resulting from users interacting with a touch-based application; a processor; and a memory, wherein the memory is arranged to store computer executable instructions which, when executed, cause the processor to: analyze the touch event data to identify a plurality of touch inputs to the game, wherein the analysis is performed independently of code for the application; and generate mapping data, the mapping data identifying at least one mapping between an identified touch input to the application and a user input via a removable input module; and transmit the mapping data to a second computing device which runs the touch-based application, wherein the mapping data is used by the computing device to generate a touch input signal for the touch-based application in response to a user input made via a removable input module.

In the fifth further example, the system may further comprise the second computing device, wherein second computing device comprises a processor and a memory arranged to store computer executable instructions which, when executed, cause the processor to: receive user input data from a touch-screen device, the user input data identifying a user input made via a removable input module; generate a touch input signal using the mapping data; and input the touch input signal to the touch-based application.

In the fifth further example, the touch event data may be generated by a plurality of touch-screen devices.

In the fifth further example, the second computing device is a touch-based user computing device or a computing device in a data center.

In any of the further examples, the touch event data may be generated by a plurality of touch-screen devices.

In any of the further examples, the touch-based application may be a touch-based game.

In any of the further examples, the touch-based application may be a game comprising at least one touch input which can be performed at a plurality of different positions on a touch-screen device.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. Propagated signals may be present in a tangible storage media (e.g. they may be stored in a tangible storage media or used in the storage process), but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method comprising:
receiving, at a computing resource, touch event data resulting from users interacting with a touch-based application;
analyzing the touch event data to identify a plurality of touch inputs to the touch-based application, wherein the analysis is performed independently of code for the application; and
generating mapping data, the mapping data identifying at least one mapping between an identified touch input to the application and a user input via a user input module.

2. The method according to claim 1, wherein the touch event data is generated by a plurality of touch-screen devices.

3. The method according to claim 1, wherein the touch-based application is a game comprising at least one touch input which can be performed at a plurality of different positions on a touch-screen device.

4. The method according to claim 1, wherein the mapping data identifies at least one mapping between an identified touch input to the application and a user input via a physical control on a user input module.

5. The method according to claim 1, wherein the computing device is a centralized computing resource or a user computing device.

6. The method according to claim 1, wherein the user input module is removable input module.

7. The method according to claim 1, further comprising:
transmitting the mapping data to a user computing device.

8. The method according to claim 7, wherein the user computing device is a touch-based computing device and wherein the touch-based computing device runs the touch-based application.

9. The method according to claim 1, further comprising:
transmitting the mapping data to a computing device which runs the touch-based application.

10. The method according to claim 1, further comprising:
receiving user input data from a touch-screen device, the user input data identifying a user input made via a user input module; and
generating a touch input signal using the mapping data.

11. The method according to claim 1, wherein analyzing the touch event data to identify a plurality of touch inputs to the touch-based application comprises:
categorizing the touch event data based on a start touch event and at least one subsequent touch event; and
identifying clusters within the categorized touch event data.

12. The method according to claim 1, wherein generating mapping data comprises:
receiving user input data in response to a touch-screen device displaying a UI presenting a touch input to the user; and
storing a mapping based on the presented touch input and the received user input data.

13. A method comprising:
transmitting touch event data resulting from users interacting with a touch-based application from a first centralized computing resource running the touch-based application to a second centralized computing resource running a mapping engine;
receiving, from the second centralized computing resource, mapping data generated by the mapping engine, the mapping data identifying at least one mapping between an identified touch input to the application and a user input via a removable input module;
receiving user input data identifying an input made via a removable input module;
generating a touch input signal based at least in part on the user input data and the mapping data; and
inputting the touch input signal to the game.

14. The method according to claim 13, wherein the touch event data is generated by a plurality of touch-screen devices.

15. The method according to claim 13, wherein the touch-based application is a game comprising at least one touch input which can be performed at a plurality of different positions on a touch-screen device.

16. A computing device comprising:
an interface configured to receive touch event data resulting from users interacting with a touch-based application;
a processor; and
a memory,
wherein the memory is arranged to store computer executable instructions which, when executed, cause the processor to:
analyze the touch event data to identify a plurality of touch inputs to the game, wherein the analysis is performed independently of code for the application; and
generate mapping data, the mapping data identifying at least one mapping between an identified touch input to the application and a user input via a user input module.

17. The computing device according to claim 16, wherein the touch event data is generated by a plurality of touch-screen devices.

18. The computing device according to claim 16, wherein the interface is a communication interface and the memory is further arranged to store computer executable instructions which, when executed, cause the processor to:
transmit the mapping data to a user computing device via the communication interface.

19. The computing device according to claim 16, wherein the interface is a communication interface and the memory is further arranged to store computer executable instructions which, when executed, cause the processor to:
transmit the mapping data to a computing device via the communication interface, wherein the computing device in the data center runs the touch-based application.

20. The computing device according to claim 16, wherein the memory is further arranged to store computer executable instructions which, when executed, cause the processor to:
receive user input data identifying a user input made via a user input module;
generate a touch input signal using the mapping data; and
input the touch input signal to the touch-based application.
